(19) United States
(12) Patent Application Publication
(10) Pub. No.: US 2021/0024085 A1
(43) Pub. Date: Jan. 28, 2021

(54) AUTOMATIC DRIVING CONTROL DEVICE FOR VEHICLE

(71) Applicant: DENSO CORPORATION, Kariya-city (JP)

(72) Inventor: Nozomi KITAGAWA, Kariya-city (JP)

(21) Appl. No.: 17/039,386

(22) Filed: Sep. 30, 2020

Related U.S. Application Data
(63) Continuation of application No. PCT/JP2019/014845, filed on Apr. 3, 2019.

(30) Foreign Application Priority Data
Apr. 4, 2018 (JP) 2018-072577

(51) Int. Cl. B60W 60/00; B60W 50/14; B60W 30/14

(52) U.S. Cl. CPC B60W 60/001; B60W 50/14; B60W 2555/60; B60W 2420/42; B60W 30/146

(57) ABSTRACT

An automatic driving control device for a vehicle that includes an actuator and an information presenting unit. The actuator controls a traveling state of the vehicle. The information presenting unit notifies an occupant of the vehicle of information. The automatic driving control device is connected to actuator for communicating. The automatic driving control device causes the vehicle to automatically travel according to a predetermined traveling condition. The automatic driving control device detects, based on information acquired from an outside of the vehicle, a regulation section that has a speed limit lower than a speed limit of the traveling condition when the vehicle is automatically traveling. The automatic driving control device outputs a deceleration command to the actuator when detecting the regulation section.

### CROSS REFERENCE TO RELATED APPLICATIONS

The present application is a continuation application of International Patent Application No. PCT/JP2019/014845 filed on Apr. 3, 2019, which designated the U.S. and claims the benefit of priority from Japanese Patent Application No. 2018-072577 filed on Apr. 4, 2018. The entire disclosures of all of the above applications are incorporated herein by reference.

### TECHNICAL FIELD

The present disclosure relates to an automatic driving control device that causes a vehicle to automatically travel according to a predetermined driving condition.

### BACKGROUND

In order to enhance safety, a speed limit display device that displays a speed limit of a road on which a vehicle is traveling to a driver is known.

In this type of device, a device is proposed in which the speed limit is recognized based on information acquired from a beacon provided on the side of the road or an image in front of the vehicle captured by an in-vehicle camera.

### SUMMARY

The present disclosure provides an automatic driving control device for a vehicle. The vehicle includes an actuator and an information presenting unit. The actuator controls a traveling state of the vehicle. The information presenting unit notifies an occupant of the vehicle of information. The automatic driving control device is connected to actuator for communicating. The automatic driving control device causes the vehicle to automatically travel according to a predetermined traveling condition. The automatic driving control device detects, based on information acquired from an outside of the vehicle, a regulation section that has a speed limit lower than a speed limit of the traveling condition when the vehicle is automatically traveling. The automatic driving control device outputs a deceleration command to the actuator when detecting the regulation section.

### BRIEF DESCRIPTION OF DRAWINGS

The features and advantages of the present disclosure will become more apparent from the following detailed description made with reference to the accompanying drawings. In the drawings:

FIG. 1 is a block diagram showing a configuration of an entire automatic driving control device according to embodiments;

FIG. 2 is a flowchart showing a regulation information presentation process according to a first embodiment;

FIG. 3 is a diagram showing time points for recognition, notification, and deceleration of speed regulation according to the first embodiment;

FIG. 4 is a flowchart showing a regulation information presentation process according to a second embodiment;

FIG. 5 is a diagram showing time points for recognition, notification, and deceleration of speed regulation according to the second embodiment;

FIG. 6 is a flowchart showing a regulation information presentation process according to a third embodiment;

FIG. 7 is a flowchart showing a regulation information presentation process according to a fourth embodiment;

FIG. 8 is a flowchart showing a regulation information presentation process according to a fifth embodiment; and

FIG. 9 is a flowchart showing a regulation information presentation process according to a sixth embodiment.

### DETAILED DESCRIPTION

For example, a speed limit stored in a navigation system may be different from the actual speed limit. A device that compares a speed limit acquired from a beacon or an in-vehicle camera with the speed limit obtained from map information of the navigation system has been proposed. The proposed device presents the highly reliable speed limit.

In a case where the proposed technique is applied to an automatic driving control device, when there is a speed limit section in which the speed limit is locally set to a lower speed than usual due to a factor such as rainfall, fog, accident, traffic jam, or the like, the vehicle can be safely travel below the speed limit within the section.

However, when there is a speed limit section in which the speed limit is set to a low speed due to the above-described external factor on the rode on which the vehicle is traveling, the vehicle manually operated by the driver may continue traveling with high speed without decelerating within the speed limit section.

Therefore, as a result of a detailed consideration by the inventor, difficulty has been found in which safety during the traveling of the vehicle is decreased due to increase of speed difference between the vehicle equipped with the automatic driving control device and the vehicle manually driven by the driver.

The present disclosure discloses an automatic driving control device that causes a vehicle to automatically travel. The automatic driving control device suppresses deterioration of safety due to increase of a speed difference with another vehicle by the vehicle decelerating in a speed limit section in which a speed limit is locally regulated.

An exemplary embodiment of the present disclosure provides an automatic driving control device for a vehicle. The vehicle includes an actuator and an information presenting unit. The actuator controls a traveling state of the vehicle. The information presenting unit notifies an occupant of the vehicle of information. The automatic driving control device includes a vehicle control unit, a speed regulation detection unit, and a notification signal output unit. The vehicle control unit is connected to the actuator for communicating. The vehicle control unit causes the vehicle to automatically travel according to a predetermined traveling condition. The speed regulation detection unit detects, based on information acquired from an outside of the vehicle, a regulation section that has a speed limit lower than a speed limit of the traveling condition when the vehicle control unit causes the vehicle to automatically travel. The speed regulation detection unit outputs a deceleration command to the actuator via the vehicle control unit when detecting the regulation section. The notification signal output unit outputs a signal to the information presenting unit to cause the information presenting unit to notify the occupant that the vehicle enters the regulation section when the speed regulation detection unit detects the regulation section.

In the exemplary embodiment of the present disclosure, the automatic travel control device can automatically drive the vehicle according to the speed limit even in the regulation section where the speed limit is set lower than the traveling condition.

When the automatic travel control device automatically drives the vehicle according in accordance with the speed limit at the regulation section, safety may decelerate due to the speed difference with another vehicle.

The notification signal output unit outputs the signal to the information presenting unit so as to notify the occupant that the vehicle will enter the regulation section when the speed regulation detection unit detects the regulation section.

Therefore, the occupant such as a driver can understand that the automatic driving control device causes the vehicle decelerate to the speed limit in the regulation section and the safety may decelerate due to increase of the speed difference with another vehicle. The configuration can cause the driver to prepare for a sudden approach of the following vehicle.

The automatic driving control device of the present disclosure causes the vehicle to decelerate at the regulation section in which the speed limit is regulated due to the weather, the road environment, or the like. Thus, the configuration can enhance safety for driving of the vehicle and suppress deceleration of safety with another vehicle.

Embodiments of the present disclosure will be described below with reference to the drawings.

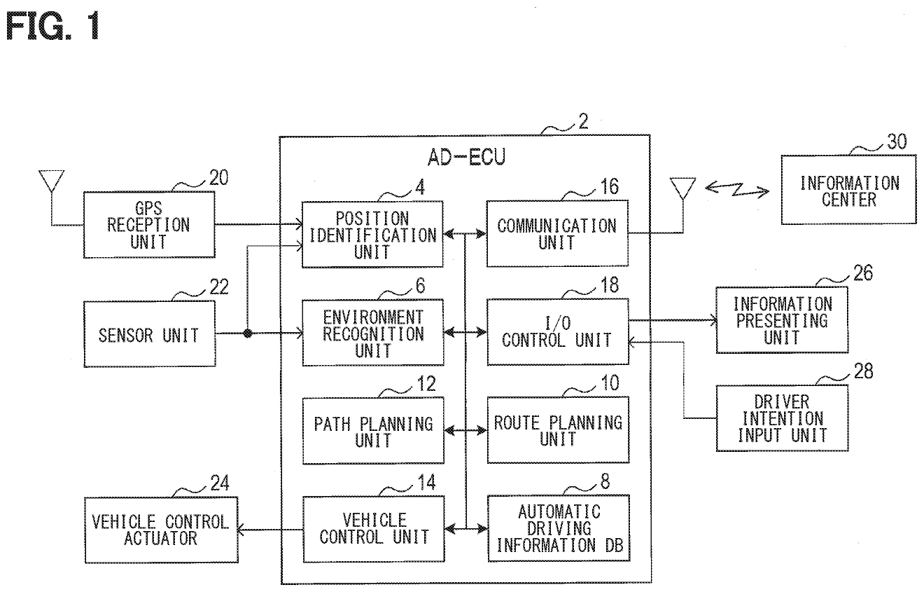

An automatic driving control device according to present embodiments is a device for automatically driving a vehicle on an automobile exclusive road such as a highway. As shown in FIG. 1, the automatic driving control device is mounted on the vehicle that includes a GPS reception unit 20, a sensor unit 22, and a vehicle control actuator 24.

The GPS reception unit 20 detects a current position of the vehicle based on radio wave transmitted from a satellite. The sensor unit 22 detects a traveling condition of the vehicle and a surrounding environment. The sensor unit 22 is provided by various sensors and an in-vehicle camera.

The vehicle control actuator 24 is used to drive and control various devices required to automatically drive the vehicle, such as an engine and a motor that generate a driving force of the vehicle, a brake device that generates a braking force, and a steering device that steers the vehicle.

The automatic driving control device of the present embodiments is an electronic control device 2 for automatic driving described as AD-ECU in FIG. 1, and is provided by a microcomputer including a CPU, a ROM, a RAM and the like. In the following description, the electronic control unit 2 will be simply referred to as the ECU 2.

The ECU 2 functions as a position identification unit 4, an environment recognition unit 6, an automatic driving information DB 8, a route plan unit 10, a path plan unit 12, a vehicle control unit 14, a communication unit 16, and an input/output (I/O) control unit 18.

Here, the automatic driving information DB 8 is a database that stores various kinds of information necessary for automatically driving the vehicle, and is provided by a non-volatile memory that is a non-transitory tangible storage medium.

Note that the automatic driving information DB 8 stores, as road information, a road profile, the number of lanes, a speed limit, an intersection, a pedestrian crossing, and the like, and the speed limit is used as the traveling condition of the present disclosure. The automatic driving information DB 8 corresponds to a storage unit of the present disclosure.

The communication unit 16 is provided by a communication circuit for performing wireless communication with an information center 30 outside the vehicle or another vehicle.

The position identification unit 4, the environment recognition unit 6, the route plan unit 10, the path plan unit 12, the vehicle control unit 14, and the input/output control unit 18 are realized by the CPU executing various programs stored in the ROM.

The position identification unit 4 identifies the current position of the vehicle based on the received signal from the GPS reception unit 20 and the detection signal from the sensor unit 22 and detects the traveling speed of the vehicle.

The environment recognition unit 6 recognizes the environment around the vehicle such as the shape of the road on which the vehicle is traveling, the road sign, the preceding vehicle, and the following vehicle based on the detection signal from the sensor unit 22 and the captured image.

The route plan unit 10 sets a travel route suitable for automatically driving the vehicle based on the road information stored in the automatic driving information DB 8. The path plan unit 12 sets the rout path, such as driving lane and lane change based on the surrounding environment recognized by the environment recognition unit 6.

The vehicle control unit 14 reads the travel route set by the route plan unit 10 and the path plan unit 12, the speed limit stored in the automatic driving information DB 8, and the like as the traveling condition, and controls the vehicle control actuator 24 according to the traveling condition.

As a result, the driving force, braking force, steering amount, or the like of the vehicle are controlled according to the traveling condition, and the vehicle is automatically driven according to the traveling condition.

The input/output control unit 18 is connected to a driver intention input unit 28 and an information presenting unit 26. The driver intention input unit 28 is used by the driver to instruct execution or cancellation of automatic driving and to set an automatic driving level at the time of automatic driving. The information presenting unit 26 presents various kinds of information to an occupant such as a driver.

In the following description of the embodiments, the information presenting unit 26 notifies the occupant of various information by audio. Alternatively, the information presenting unit 26 may notify the occupant of various information by lighting a display lamp or displaying an image on the display. Further, the information presenting unit 26 may vibrate the driver's seat when the driver is warned.

Then, the input/output control unit 18 controls the operation of each of the above units according to a command from the driver intention input unit 28.

Further, when the environment recognition unit 6 recognizes a road sign indicating the speed limit of the traveling road from the image captured by the in-vehicle camera of the sensor unit 22 during the automatic driving by the vehicle control unit 14, the input/output control unit 18 performs the speed regulation detection process for acquiring the speed limit.

This speed regulation detection process is one of the programs executed by the CPU in order to realize the function of the speed regulation detection unit and the notification signal output unit of the present disclosure in the ECU 2.

The speed regulation detection process compares the speed limit of the traveling road acquired from the environment recognition unit 6 with the speed limit stored in the automatic driving information DB 8. When it is detected that the speed limit of the road on which the vehicle is traveling is lower than the usual speed limit, the vehicle control unit 14 is notified of the information.

The road having the speed limit lower than usual indicates a road where the speed is locally regulated due to a weather condition such as rain or fog, traffic congestion due to accident, construction, traffic concentration, or the like.

Hereinafter, the speed regulation detection process executed by the input/output control unit 18 as the speed regulation detection unit and the notification signal output unit of the present disclosure will be described.

### First Embodiment

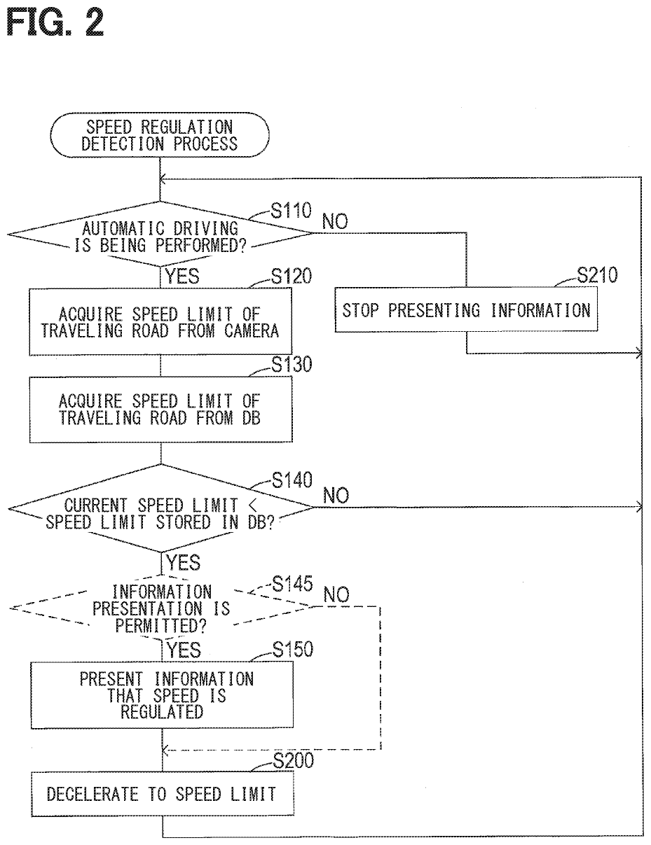

As shown in FIG. 2, in the speed regulation detection process of a present embodiment, first in S110, it is determined whether the vehicle is currently being automatically driven under the control of the vehicle control unit 14. When it is determined in S110 that the vehicle is not being automatically driven, the information presentation regarding the automatic driving by the information presenting unit 26 is stopped, and the process proceeds to S110 again.

On the other hand, when it is determined in S110 that the vehicle is in automatic driving, the process proceeds to S120. In S120, the current speed limit of the point at which the vehicle is traveling obtained from the image captured by the in-vehicle camera is acquired from the environment recognition unit 6. Note that, in this process, the environment recognition unit 6 functions as the information acquisition unit of the present disclosure.

Then, in subsequent S130, the speed limit of the same travel point as the speed limit acquired in S120 is acquired from the automatic driving information DB 8, and the process proceeds to S140. In S140, the current speed limit of the travel point acquired from the environment recognition unit 6 in S120 is compared with the speed limit acquired from the automatic driving information DB 8 in S130.

As a result of the comparison of the speed limits in S140, when the current speed limit acquired from the environment recognition unit 6 is lower than the speed limit acquired from the automatic driving information DB 8, it is determined that the road on which the vehicle is currently traveling is locally regulated and the process proceeds to S150.

In S150, the information presenting unit 26 presents the information indicating that deceleration is necessary on the traveling road because the speed is regulated, and that the following vehicle may approach due to deceleration to an occupant such as a driver.

That is, the information presenting unit 26 presents a sound message, for example, “The speed limit is regulated to X km per hour. Be careful of a speed difference with surrounding vehicle.” With the message, the information presenting unit 26 alerts the occupant. In addition, X is an arbitrary value.

When the information presentation in S150 is performed, the process proceeds to S200. In S200, a deceleration command to decelerate the vehicle at the speed limit acquired from the environment recognition unit 6 is output to the vehicle control unit 14 in order that the vehicle control actuator 24 causes the vehicle to decelerate and the process proceeds to S110.

In S140, when the current speed limit acquired from the environment recognition unit 6 is not lower than the speed limit acquired from the automatic driving information DB 8, it is determined that the road on which the vehicle is currently traveling is not locally regulated and the process proceeds to S110.

As described above, in the speed regulation detection process of the present embodiment, when the current speed limit of the traveling road obtained from the image captured by the in-vehicle camera is lower than the normal speed limit stored in the automatic driving information DB 8, the occupant is notified of the information by voice.

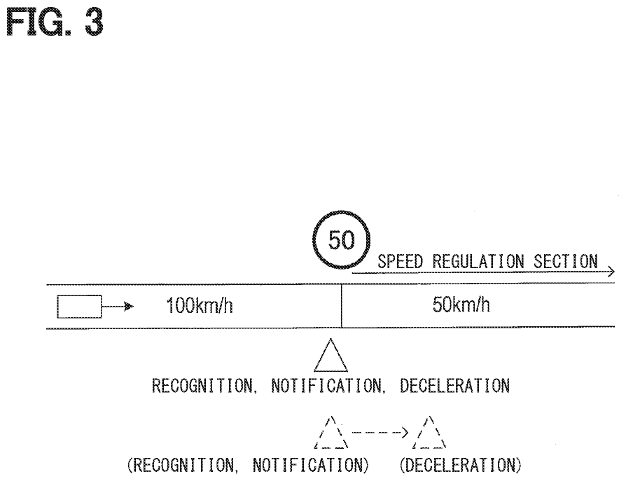

Therefore, as shown in FIG. 3, when the vehicle is automatically traveling on a road with a speed limit of 100 km/h, the speed limit is locally regulated to 50 km/h due to weather condition or traffic congestion. When the vehicle enters the speed regulation section, the speed regulation can be recognized ahead of the regulation section by the road sign. When the speed regulation is recognized, the occupant is notified of the information. The occupant recognizes the information and the vehicle can decelerate at the speed limit.

Therefore, according to the present embodiment, the occupant such as a driver can understand that the automatic driving control device causes the vehicle decelerate to the speed limit in the regulation section and the safety may decelerate due to increase of the speed difference with another vehicle. The configuration can cause the driver to prepare for a sudden approach of the following vehicle.

Further, when the driver receives the deceleration information presentation, the driver can suppress the rapid deceleration of the vehicle by canceling the automatic driving through the driver intention input unit 28 and starting the manual driving as necessary. Further, for example, the driver of the following vehicle can be informed that the subject vehicle is decelerating by turning on the hazard lamp without canceling the automatic driving.

Therefore, the automatic driving control device of the present embodiment can enhance the safety when the vehicle enters the regulation section during the automatic driving.

### (Modification)

In the above description, in S140, when the current speed limit acquired from the environment recognition unit 6 is lower than the speed limit acquired from the automatic driving information DB 8, the process proceeds to S150. In S150, the information that the vehicle will decelerate due to the speed limit of the road on which the vehicle is traveling is presented.

However, some drivers do not need such information presentation and may find the information annoying. Therefore, it may be possible to set not to present the information from the driver intention input unit 28.

In this case, when it is determined in S140 that the speed limit of the traveling road is lower than usual, the process proceeds to S145. In S145, as shown by the dotted line in FIG. 2, it is determined whether the presentation of the information is permitted.

When it is determined in S140 that the information presentation is permitted, the process proceeds to S150. When the information presentation is not permitted, the process proceeds to S200 and the vehicle is decelerated to the speed limit.

Permission and prohibition of such information presentation can be set through the driver intention input unit 28 capable of being operated by the driver. Alternatively, permission and prohibition of such information presentation may be set by a vehicle dealer or the like at the time of vehicle sale or maintenance by switching the operation setting of the ECU 2.

### Second Embodiment

In the speed regulation detection process of the first embodiment shown in FIG. 2, the environment recognition unit 6 acquires the speed limit in S120, and the speed limit acquired by the environment recognition unit 6 and the speed limit stored in the automatic driving information DB 8 are compared in S140.

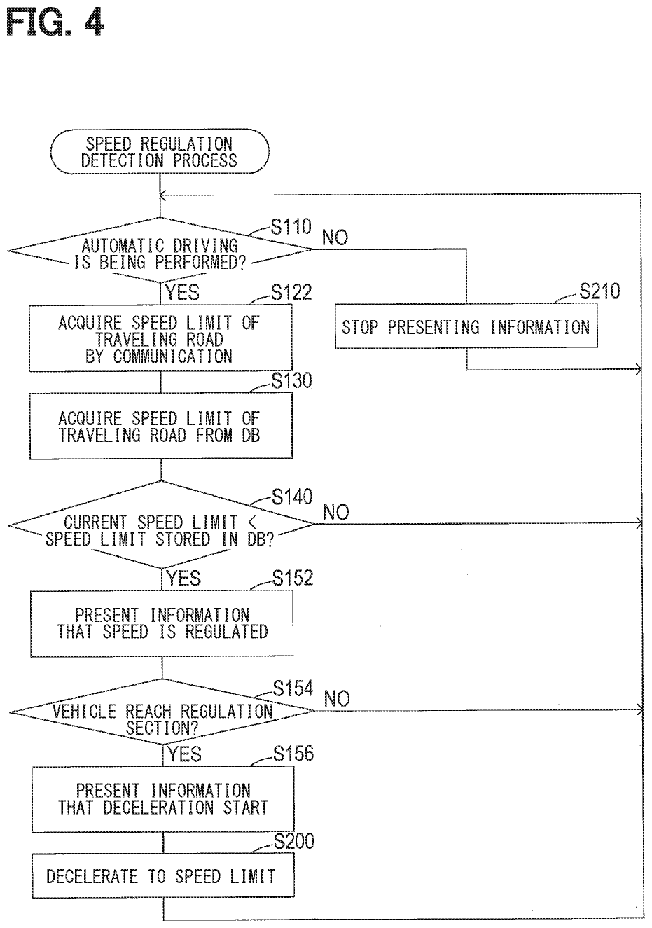

In the speed regulation detection process of the present embodiment, as shown in FIG. 4, instead of the process of S120, the process of S122 is performed. In S122, the speed limit of the road ahead of the vehicle is acquired from the information center 30 outside the vehicle via the communication unit 16.

In S122, when the speed limit of the road ahead of the vehicle is acquired, the speed limit for a predetermined distance away from the current position of the vehicle or the speed limit after traveling a predetermined time from the current position is acquired in advance by acquiring the current position and the traveling direction of the vehicle from the position identification unit 4. The communication unit 16 functions as the information acquisition unit of the present disclosure in the process of S122.

In S140, the speed limit acquired from the information center 30 is compared with the speed limit stored in the automatic driving information DB 8. When the speed limit acquired from the information center 30 is lower than the speed limit of the automatic driving information DB 8, the process proceeds to S152.

In S152, the speed limit obtained from the information center 30 is lower than the speed limit in the automatic driving information DB 8, and therefore the information presenting unit 26 is caused to present the information for announcing that the vehicle is going to decelerate due to the speed limit.

That is, the speed limit in the regulation section can be acquired from the information center 30 before the vehicle reaches the regulation section. In S152, for example, it is announced that “The speed limit is regulated to X km/h. Deceleration will start after Y seconds.” In addition, X and Y are arbitrary values.

Further, in S152, when the regulation section is detected by the speed limit comparison in S140, at least the first detected regulation section is stored in the memory. As a result, while the vehicle is traveling, it is possible to successively update the time Y until the vehicle enters the regulation section, and accurately grasp the location where deceleration should be started.

Next, in S154, the current position of the vehicle is acquired from the position identification unit 4, and it is determined whether the vehicle has reached the regulation section where the speed limit is set lower than usual. When the vehicle has reached the regulation section, the process proceeds to S156. When it is determined in S154 that the vehicle has not reached the regulation section, the process proceeds to S110 and the above process is executed again.

Then, in S156, the information presenting unit 26 is caused to present information that the deceleration of the vehicle is started. The information presenting unit 26 may output a vice message, for example, “The vehicle is decelerated. Be careful of a speed difference between surrounding vehicles.”

Further, after the information is presented in S156, the vehicle is decelerated to the speed limit by outputting a deceleration command to the vehicle control unit 14 in S200, and the process proceeds to S110.

As described above, in the speed regulation detection process of the present embodiment, the regulation section where the speed limit is lower than usual on the traveling road ahead of the vehicle is detected from the information center 30 outside the vehicle via the wireless communication.

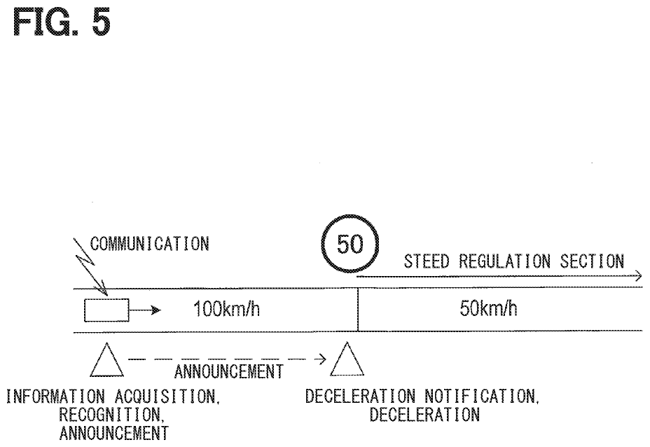

As shown in FIG. 5, the regulation section can be grasped before a predetermined time or a predetermined distance prior to the vehicle entering the regulation section, and the information can be announced to the occupant before the vehicle enters the regulation section.

In addition, a vehicle occupant such as a driver understands that the vehicle will be decelerated at the regulation section when the vehicle continues to be driven by the automatic driving control device. When another vehicle exists around the subject vehicle, the driver can switch to the manual operation before the automatic driving control device decelerates and adjust the speed difference with another vehicle.

In addition, the announcement for deceleration in S152 is repeatedly executed until the vehicle reaches the regulation section at which deceleration actually starts. Therefore, the configuration can more reliably notify the occupant that the vehicle will enter the speed regulation section.

When the driver does not switch to the manual operation after the announcement and the vehicle enters the speed regulation section, it is notified that the vehicle will decelerate and the vehicle decelerates to the speed limit. Thus, the same effect can be exhibited as the effect of the first embodiment.

### Third Embodiment

In the speed regulation detection process of the first embodiment shown in FIG. 2, when it is determined in S140 that the speed is regulated on the road on which the vehicle is traveling, the occupant is notified in S150 and then the vehicle is decelerated to the speed limit in S200.

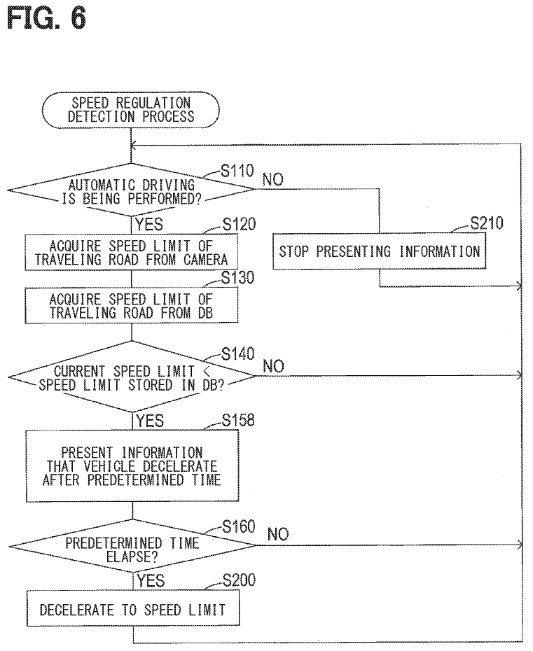

In a speed regulation detection processing of the present embodiment, as shown in FIG. 6, when it is determined in S140 the speed is regulated on the road on which the vehicle is traveling, the information that the vehicle will decelerate after a predetermined time is presented in S158.

The information presenting unit 26 may output a voice message, for example, “The speed limit is regulated to X km per hour. Deceleration will start after Y seconds. Be careful of a speed difference between surrounding vehicle.”

After detecting that the speed of the traveling road is regulated in S140, it is determined whether a predetermined time has elapsed in S160. When the predetermined time has not elapsed, the process proceeds to S110.

When the predetermined time has elapsed, the process proceeds to S200. In S200, a deceleration command is output to the vehicle control unit 14 to cause the vehicle control actuator 24 to decelerate the vehicle to the speed limit, and the process proceeds to S110.

That is, in the present embodiment, when it is detected that there is a speed limit on the traveling road, the vehicle is not immediately decelerated but decelerated to the speed limit after a predetermined time elapses as shown by the dotted line in FIG. 3.

Therefore, according to the present embodiment, the driver can switch to the manual driving in consideration of the distance with the surrounding vehicle or the like from the time when the driver recognizes that there is the speed limit on the traveling road by the voice message output from the information presenting unit 26 until the vehicle starts decelerating. Further, for example, a hazard lamp may be turned on to notify surrounding vehicle that the subject vehicle will decelerate.

Therefore, according to the present embodiment, it is possible to further improve the safety when the vehicle enters the speed regulation section during automatic driving.

### Fourth Embodiment

In the speed regulation detection process of the first embodiment shown in FIG. 2, when it is determined in S140 that the speed is regulated on the road on which the vehicle is traveling, the occupant is notified in S150 and then the vehicle is decelerated to the speed limit in S200.

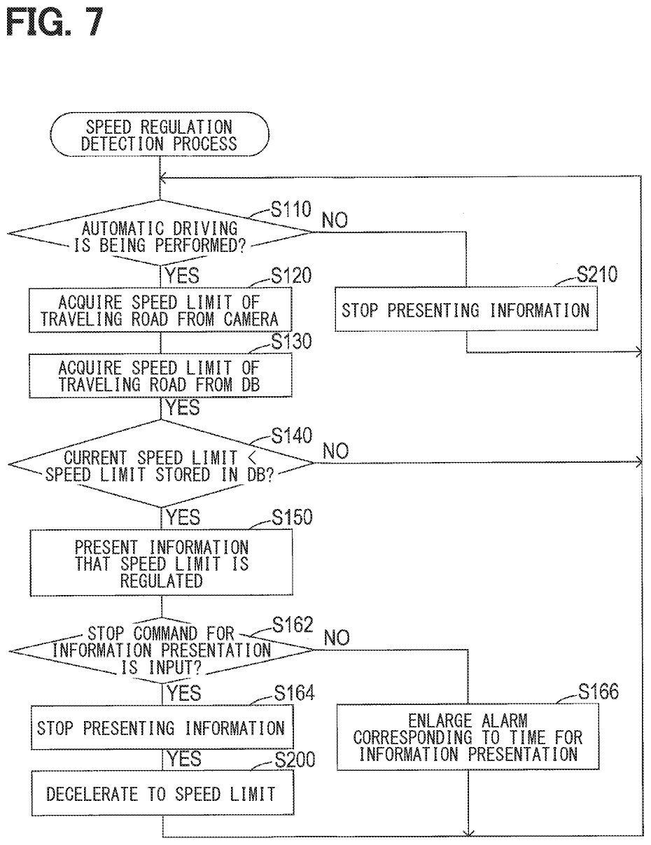

In the speed regulation detection process of the present embodiment, as shown in FIG. 7, the occupant is notified that the speed on the road on which the vehicle is traveling regulated is S150.In S162, it is determined whether an information presentation stop command is input.

That is, in S162, in response to the information presentation in S150, it is determined whether the driver has operated the driver intention input unit 28 to input the information presentation stop command.

In S162, when it is determined that the information presentation stop command has been input, it is determined that the driver confirms the information presentation and approves to decelerate the vehicle, and the process proceeds to S164. In S164, the information is stop being presented, and the process proceeds to S200.

On the other hand, when it is determined in S162 that the information presentation stop command has not been input, the process proceeds to S166. In S166, level of alert of the information presentation is increased corresponding to the lapse of time from start of information presentation in S150, and the process proceeds to S110.

For example, in order to increase the level of alert for the vehicle traveling at the regulation section on the road, the volume of a voice message that presents information increases or the content of the voice message is changed. Thus, the driver can surely recognize the necessity that the vehicle decelerates.

As described above, in the present embodiment, the information presentation continues from the first information presentation in S150 until the input of the information presentation stop command by the driver operating the driver intention input unit 28. In addition, the alert level for the information presentation increases corresponding to the elapsed time.

Therefore, the configuration can cause the driver to more reliably recognize that the vehicle will decelerate at the regulation section. It is possible to further improve the safety for the vehicle traveling in the regulation section.

### (Modification)

In the speed regulation detection process shown in FIG. 7, the process of S200 for outputting a deceleration command to the vehicle control unit 14 is performed after the driver inputs the stop command for information presentation. The process of S200 may be performed before the stop command for information presentation is input.

That is, as in the first embodiment, deceleration may be started immediately after the regulation section is detected. Alternatively, as in the second embodiment, deceleration may be started after the vehicle reaches the regulation section. Alternatively, as in the third embodiment, deceleration may be started after a predetermined time has elapsed from the detection of the regulation section.

In this configuration, when the deceleration of the subject vehicle is started, the driver can recognize that the difference in the speed with the following vehicle and the following vehicle may suddenly approach the subject vehicle.

Therefore, according to this modification, even when the automatic driving control device is operating at the automatic driving level 3 or higher which does not require the driver to concentrate on driving, the driver can recognize that the vehicle decelerates at the regulation section.

In this case, the degree of increasing of alert level in S166 may be adjusted based on the speed difference with the following vehicle after deceleration.

For example, when the speed of the following vehicle is 100 km/h and the speed of the subject vehicle is 80 km/h, the change amount of the alert level is reduced and when the speed of the following vehicle is 100 km/h and the speed of the subject vehicle is 50 km/h, the change amount of the alert level is increased.

In addition, the information presentation in S150 may be started before the vehicle decelerates at the regulation section, or may be started after the vehicle decelerates at the regulation section.

The information presentation before the deceleration of the vehicle is started may be changed by the following 1) to 3) according to the time until the driver inputs the information presentation stop command. With the information presentation, the level of alert can be increased.

1) Notify that the maximum speed is limited lower than usual.

2) Notify that the maximum speed is limited lower than usual and that the speed difference with surrounding vehicle will be large.

3) Notify that the maximum speed is limited to a lower value than usual, that the speed difference with surrounding vehicle will be large, and that there is a possibility of being hit by the following vehicle.

The information presentation after the deceleration of the vehicle is started may be changed by the following 4) and 5) according to the time until the driver inputs the information presentation stop command. With the information presentation, the level of alert can be increased.

4) Notify that the maximum speed is limited lower than usual and that the speed difference with surrounding vehicle is large.

5) Notify that the maximum speed is regulated to a lower value than usual, that the speed difference with surrounding vehicle is large, and that there is a possibility of being hit by the following vehicle.

### Fifth Embodiment

In the speed regulation detection processing of the above-described first to fourth embodiments, when it is determined that the speed of the road on which the vehicle is traveling is regulated in S140, the occupant is notified of the information in the subsequent processing.

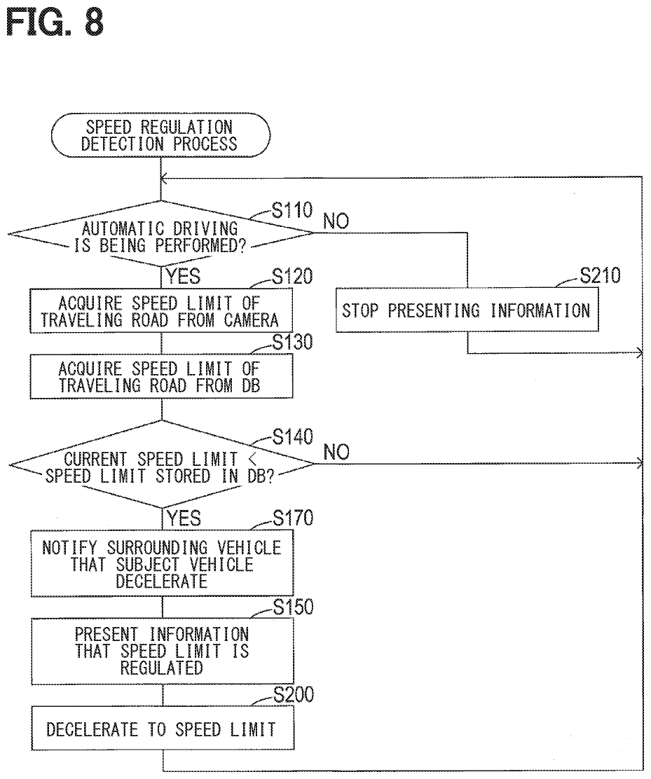

In the present embodiment, as shown in FIG. 8, when it is determined in S140 that the speed on the road on which the vehicle is traveling is regulated, the surrounding vehicle is notified in S170 that the subject vehicle will decelerate, and then the process proceeds to S150.

As a result, according to the present embodiment, not only the driver of the subject vehicle but also the driver of the surrounding vehicle can recognize that the subject vehicle decelerates because the speed of the traveling road is regulated. Thus, the configuration can enhance the safety when the vehicle travels in a regulation section where the speed limit is locally regulated.

In S170, when notifying the surrounding vehicle that the subject vehicle decelerates, the brake lamp or the hazard lamp may be turned on, or the indicator for the outside of the vehicle may be used.

In replace of such visual notification, voice, warning sound, or auditory notifying means, vehicle-to-vehicle communication, or a combination thereof may be used. In vehicle-to-vehicle communication, information may be presented by operating a display device or a sound device of the surrounding vehicle.

Further, the notification to the surrounding vehicle in S170 may be performed regardless of the presence or absence of the surrounding vehicle, or may be performed when the environment recognition unit 6 detects the surrounding vehicle.

When the notification is performed regardless of the presence or absence of the surrounding vehicle, the driver of the following vehicle whose speed difference with the subject vehicle increases can be notified that the subject vehicle decelerates before the following vehicle catches up with the subject vehicle. Thus, the driver of the following vehicle can more reliably notified that the subject vehicle decelerates.

That is, a following vehicle in which the speed difference with the subject vehicle increases due to the deceleration of the subject vehicle, particularly a following vehicle that violates the speed, immediately catches up with the subject vehicle when the subject vehicle decelerates. Therefore, in this case, the notification after the environment recognition unit 6 recognizes the following vehicle may be late.

When the notification is given to the surrounding vehicle regardless of the presence or absence of the surrounding vehicle, it is possible to more reliably notify the driver of the following vehicle that the subject vehicle decelerates, thereby improving safety.

On the other hand, the surrounding vehicle may be notified that the subject vehicle decelerates after the environment recognition unit 6 detects the surrounding vehicle. In this case, the notification operation to the surrounding vehicle can be suppressed to the necessary minimum and the power consumption can be reduced.

### Sixth Embodiment

In the speed regulation detection process of the fifth embodiment shown in FIG. 8, the drivers of the surrounding vehicle and the subject vehicle are notified that the subject vehicle will decelerate at the regulation section in S170 and S150, and then the subject vehicle decelerates to the speed limit in S200.

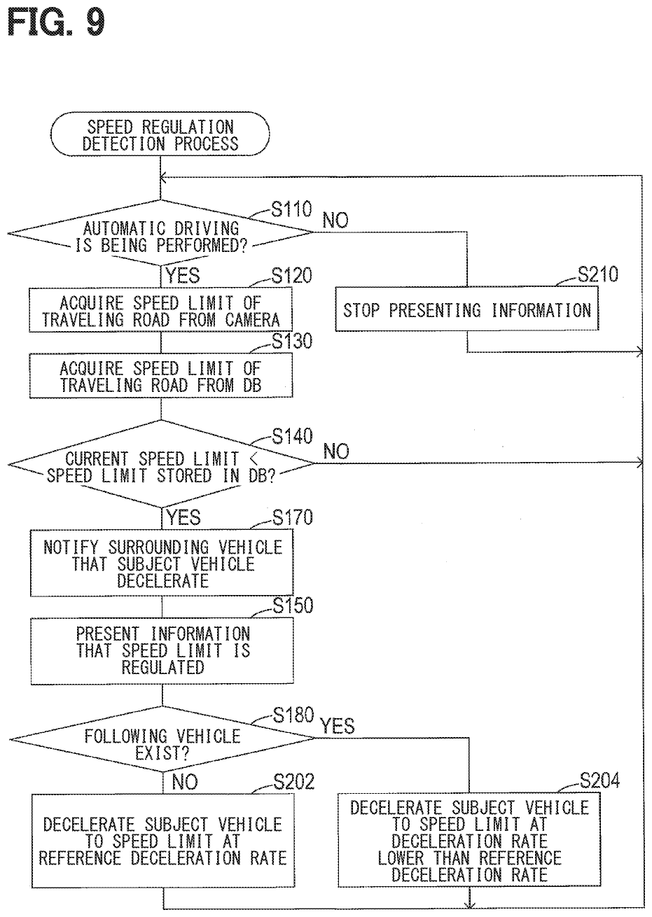

In the present embodiment, as shown in FIG. 9, after the drivers of the surrounding vehicle and the subject vehicle are notified in S170 and S150, it is determined whether the following vehicle exists in S180. In S180, it is determined whether the environment recognition unit 6 recognizes the following vehicle.

When it is determined in S180 that the following vehicle does not exist, the process proceeds to S202. In S202, a deceleration command to the vehicle control unit 14 is output in order to decelerate the subject vehicle to the speed limit at a predetermined reference deceleration rate. After the vehicle decelerates, the process proceeds to S110.

When it is determined in S180 that the following vehicle exists, the process proceeds to S204. In S204, a deceleration command to the vehicle control unit 14 is output in order to decelerate the subject vehicle to the speed limit at a deceleration rate lower than the reference deceleration rate. After the vehicle decelerates, the process proceeds to S110.

That is, when a following vehicle exists, difference in speed with the following vehicle may be big and the following vehicle may approach rapidly in the case where the subject vehicle decelerates at the reference deceleration rate. Therefore, the subject vehicle decelerates gradually by setting the deceleration rate to be smaller than the reference deceleration rate.

As a result, it is possible to suppress rapid approach of the following vehicle by the subject vehicle decelerating, and further improve safety during deceleration.

In S204, the deceleration rate used for the subject vehicle decelerating to the speed limit may be a fixed value smaller than the reference deceleration rate, or may be set according to the speed difference between the speed before deceleration and the speed limit, which is a target speed for deceleration.

Further, the deceleration rate may be set according to the inter-vehicle distance to the following vehicle. Alternatively, the deceleration rate may be set according to the speed of the subject vehicle and the inter-vehicle distance to the following vehicle. Alternatively, the deceleration rate may be set according to the speed of the subject vehicle, the speed of the following vehicle, and the inter-vehicle distance to the following vehicle.

Although embodiments of the present disclosure have been described above, the present disclosure is not limited to the above-described embodiments but various modifications can be made.

For example, in the above-described embodiments, when the occupant such as the driver is notified that the vehicle enters the regulation section for the speed limit and the vehicle decelerates in the regulation section, a voice message is sent from the information presenting unit 26.

Such information presentation may be performed by turning on a display lamp provided in the information presenting unit 26, by displaying an image on the display, or a combination of thereby and voice. In addition, the driver's seat may be vibrated when the level of the alert for the information presentation increases.

Further, in the speed regulation detection process of the second to sixth embodiments, the occupant may set the information presentation not be performed through the driver intention input unit 28 as in the modification of the first embodiment.

Further, in the speed regulation detection process of the fifth and sixth embodiments, the process that notifies the surrounding vehicle of the information that the subject vehicle decelerates in S170 may be performed by an automatic driving control device that does not notify the driver of the subject vehicle of deceleration.

With this configuration, the automatic driving control device cannot notify the driver of the subject vehicle of the fact that the vehicle enters the regulation section whose speed limit is set low, but can notify the driver of the following device of the fact.

Therefore, when the environment recognition unit 6 detects the regulation section whose speed limit is set low and the subject vehicle decelerates at the speed limit, the configuration can suppress rapid approach to the following vehicle by increasing the speed difference between the following vehicle manually driven. That is, even in this case, the intended purpose of the automatic driving control device of the present disclosure can be achieved.

In addition, multiple functions of one component in the above embodiment may be realized by multiple components, or a function of one component may be realized by multiple components. In addition, multiple functions of multiple components may be realized by one component, or a single function realized by multiple components may be realized by one component. A part of the configuration of the above embodiment may be omitted. At least a part of the configuration of the above embodiments may be added to or replaced with the configuration of another one of the above embodiments. Further, all aspects included in the technical ideas specified only by the language described in the claims are considered embodiments of the present disclosure.

What is claimed is:

1. An automatic driving control device for a vehicle, the vehicle including an actuator configured to control a traveling state of the vehicle and an information presenting unit configured to notify an occupant of the vehicle of information, the automatic driving control device comprising a processor connected to the actuator for communicating and configured to;
cause the vehicle to automatically travel according to a predetermined traveling condition;
detect, based on information acquired from an outside of the vehicle, a regulation section that has a speed limit lower than a speed limit of the traveling condition when the vehicle is automatically traveling;
output a deceleration command to the actuator after a lapse of predetermined time since the regulation section is detected; and
output a signal to the information presenting unit to cause the information presenting unit to notify the occupant that the vehicle enters the regulation section when the regulation section is detected.

2. The automatic driving control device according to claim 1, wherein
the processor recognizes the speed limit of a road on which the vehicle is traveling from an image around the vehicle captured by an in-vehicle camera, and compares the speed limit of the road with the speed limit of the traveling condition to detect the regulation section.

3. The automatic driving control device according to claim 1, wherein
the processor detects the regulation section by a predetermined time before or a predetermined distance before the vehicle enters the regulation section by communicating with an information center outside the vehicle.

4. The automatic driving control device according to claim 1, wherein
when the processor detects the regulation section, the processor outputs the signal to the information presenting unit to notify the occupant that the vehicle enters the regulation section until the vehicle enters the regulation section.

5. The automatic driving control device according to claim 1, wherein
when the processor detects the regulation section, the processor outputs the signal to the information presenting unit to notify the occupant that the vehicle enters the regulation section until approval of the occupant is acquired.

6. The automatic driving control device according to claim 5, wherein
the processor outputs a signal to the information presenting unit to increase a level of alert for notifying the occupant that the vehicle enters the regulation section according to a lapse of time since the processor detects the regulation section.

7. The automatic driving control device according to claim 1, wherein
the processor is configured to set the information presenting unit not to notify the occupant that the vehicle enters the regulation section.

8. The automatic driving control device according to claim 1, wherein:
the information presenting unit presents information to a following vehicle; and
when the processor detects the regulation section, the processor outputs a signal to the information presenting unit to notify the following vehicle that the vehicle decelerates.

9. The automatic driving control device according to claim 1, wherein:
when the processor detects the regulation section during automatic driving of the vehicle, the processor determines whether a following vehicle exists based on the information acquired from the outside of the vehicle; and
when the following vehicle exists, the processor outputs, to the actuator, a deceleration command of which a deceleration rate is smaller than a reference deceleration rate of a deceleration command output when the following vehicle does not exist.

10. An automatic driving control device for a vehicle, the vehicle including an actuator configured to control a traveling state of the vehicle and an information presenting unit configured to notify an occupant of the vehicle of information, the automatic driving control device comprising a processor configured to:
store a traveling condition used for automatically traveling the vehicle;
output a signal to the actuator based on the traveling condition to cause the vehicle to automatically travel;
acquire information related to a speed limit from at least one of sensor units attached to the vehicle and an information center outside the vehicle;
detect a regulation section of which the speed limit is lower than a speed limit of the traveling condition based on the information acquired from the at least one of sensor units and the information center;
output a signal to the information presenting unit to notify the occupant that the vehicle enters the regulation section before the vehicle reaches the regulation section; and
output a deceleration command to the actuator when the vehicle reaches the regulation section.

11. An automatic driving control device for a vehicle, the vehicle including an actuator configured to control a traveling state of the vehicle and an information presenting unit configured to notify an occupant of the vehicle of information, the automatic driving control device comprising:
a vehicle control unit connected to the actuator for communicating and configured to cause the vehicle automatically travel according to a predetermined traveling condition;
a speed regulation detection unit configured to (i) detect, based on information acquired from an outside of the vehicle, a regulation section that has a speed limit lower than a speed limit of the traveling condition when the vehicle control unit causes the vehicle to automatically travel and (ii) output a deceleration command to the actuator via the vehicle control unit after a lapse of predetermined time since the regulation section is detected; and
a notification signal output unit configured to output a signal to the information presenting unit to cause the information presenting unit to notify the occupant that the vehicle enters the regulation section when the regulation section is detected.
